(19) United States
(12) Patent Application Publication
(10) Pub. No.: US 2013/0308619 A1
(43) Pub. Date: Nov. 21, 2013

(54) LIGHTING INSTRUMENT HAVING WIRELESS NETWORK SHARING FUNCTION

(71) Applicant: Nai-Chien CHANG, New Taipei City (TW)

(72) Inventor: Nai-Chien CHANG, New Taipei City (TW)

(21) Appl. No.: 13/830,947

(22) Filed: Mar. 14, 2013

(30) Foreign Application Priority Data
May 16, 2012 (TW) 101209264

(51) Int. Cl. F21V 33/00

(52) U.S. Cl. CPC F21V 33/00
USPC 370/338

(57) ABSTRACT

A light instrument having wireless network sharing function includes a decorative light and a wireless network access point disposed within a base of the decorative light. Therefore, the decorative light not only can provide function of illumination, but internet for electronic apparatus having WIFI equipment when the wireless network access point is electrically connected to a modem.

### BACKGROUND OF THE INVENTION

1. Field of the Invention

The present invention relates to a lighting instrument, and in particular o lighting instrument having wireless network access point.

2. Description of Related Art

Light instrument is an indispensable electric equipment in our daily lives, and is classified into ceiling light or bracket light mounted on ceiling or wall and table lamp, decorative light or landing light stood on desk or floor.

In the structures of table lamp, decorative light and landing light, a base is provided. The base has a neck portion, and the neck portion has at least one electrically connective socket. A lamp bulb and a lamp shell are disposed on the electrically connective socket. The lamp shell reflects light generated from the lighting lamp bulb. However, a waste of an internal space of the base is resulted by that the internal space of the base is just designed to be hollow for placing electronic ballast, starter or converter, and a lot of space in the base is not completely used.

Furthermore, hollow design of the base in some table lamp, decorative light and landing light causes phenomenon of top-heavy, such that a slight bump or shake will cause the table lamp, decorative light and landing light to fall.

### SUMMARY OF THE INVENTION

It is an aspect to provide light instrument having wireless network sharing function to provides not only illumination, but function of wireless network connection, and can solve the problem of that an internal space of the base is not complement used in conventional light instrument.

Moreover, a wireless network access point is disposed within the base can increase the weight of the light instrument, such that the light instrument can stable stand on table or floor.

Accordingly, the light instrument having wireless network sharing function according to one aspect of the present invention is provided. The light instrument having wireless network sharing function is electrically connected to a modem and is wireless connected to electronic apparatus having wireless local area network equipment. The lighting instrument having wireless network sharing function comprises a decorative light and a wireless network access point assembled within the decorative light.

The decorative light comprises a base, a light generating component, and a lamp shell. The base comprises an accommodating space for accommodating the wireless network access point and a neck portion extending from the base, one end of the neck portion has an electrically conductive socket. The light generating component is electrically connected to the electrically conductive socket. The lamp shell is assembled with the end of the neck portion and covers the light generating component.

In an embodiment of the present invention, wherein the light instrument having wireless network sharing function further comprises a power switch disposed on the base and electrically connected to the wireless network access point.

In an embodiment of the present invention, wherein the light generating component is incandescent bulb, fluorescent tube, halogens bulb, light emitting diode bulb, tungsten bulb or gas discharge bulb.

In an embodiment of the present invention, wherein the wireless network assess point comprises a circuit board, an antenna, a plurality of electric connectors, and a displaying unit. The circuit board has traces for the wireless network access point. The antenna is electrically connected to the circuit board. The electric connectors are electrically connected to the circuit board. The displaying unit is disposed on the base or the neck portion and electrically connected to the circuit board for displaying usage states of network connection.

In an embodiment of the present invention, wherein the antenna comprises an antenna joint and a radiating body, the antenna joint is fixed on the base or neck portion of the decorative light and electrically connected to the circuit board, the radiating body comprises a pivoting axis electrically connected to the antenna joint.

In an embodiment of the present invention, the radiating body is of pillar shape or stick shape.

In an embodiment of the present invention, the electric connectors are network connectors.

In an embodiment of the present invention, the electric connectors are RJ4S connectors.

In an embodiment of the present invention, the displaying unit is composed of a plurality of light emitting diodes.

In an embodiment of the present invention, wherein the circuit board further comprises a power rectifying and voltage stabilizing unit electrically connected to the light generating component.

In an embodiment of the present invention, wherein a power rectifying and voltage stabilizing unit is disposed within the base and electrically connected to the light generating component and the circuit board.

### BRIEF DESCRIPTION OF DRAWING

The features of the invention believed to be novel are set forth with particularity in the appended claims. The invention itself, however, may be best understood by reference to the following detailed description of the invention; which describes an exemplary embodiment of the invention, taken in conjunction with the accompanying drawings, in which:

FIG. 1 is a schematic view of a lighting instrument according to the present invention.

FIG. 2 is a side view of the lighting instrument according to the present invention.

FIG. 3 is a schematic view of usage state of the lighting instrument according to the present invention.

FIG. 4 is a circuit diagram of the lighting instrument according to the present invention.

### DETAILED DESCRIPTION OF THE INVENTION

A preferred embodiment of the present invention will be described with reference to the drawings.

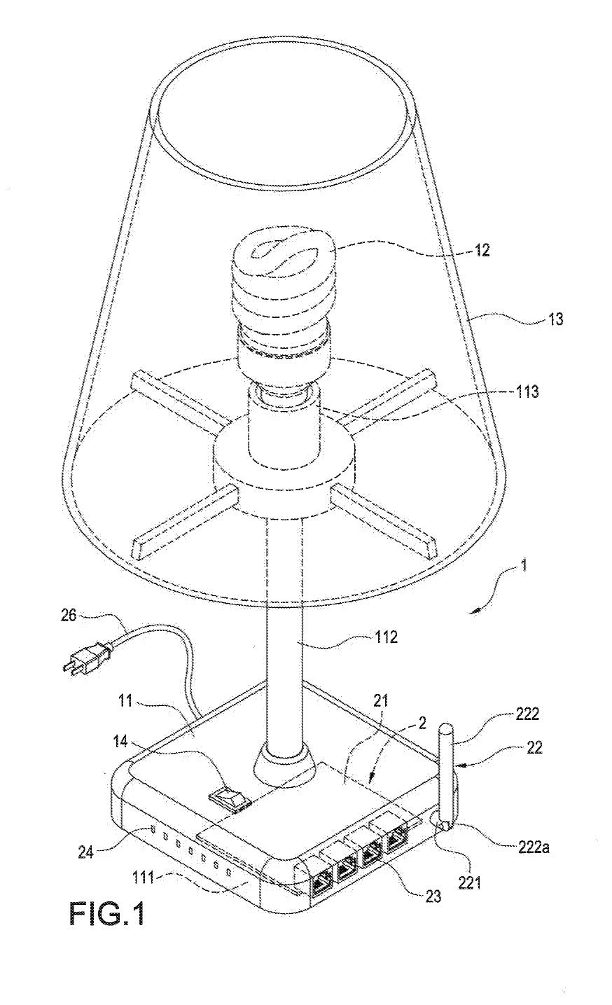

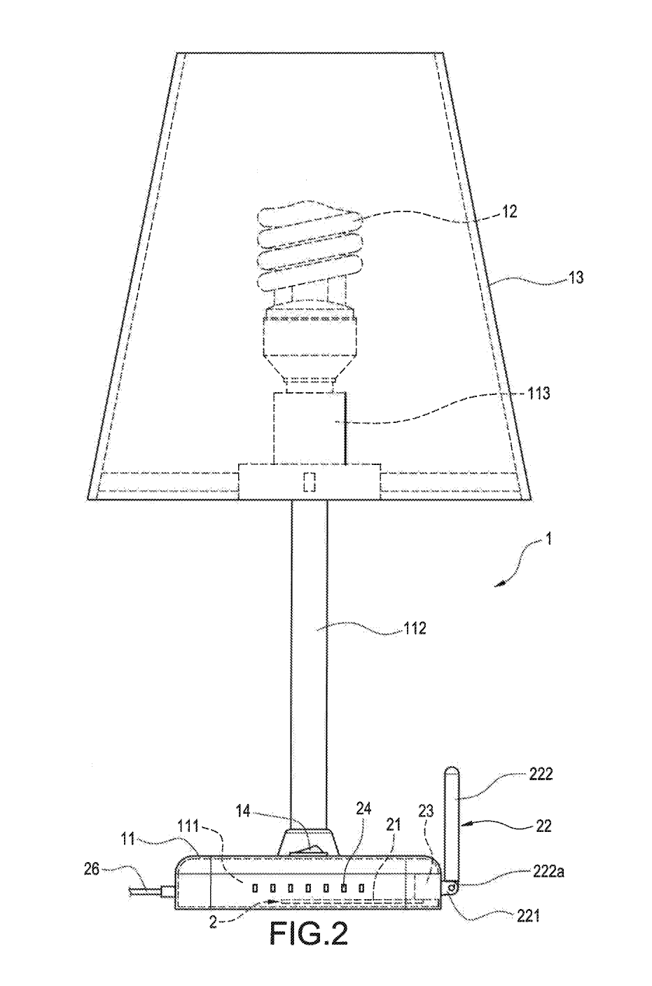

Reference is made to FIG. 1 and FIG. 2. FIG. 1 is a schematic view of a light instrument having wireless network sharing function according to the present invention, and FIG. 2 is a side view of the light instrument having wireless network sharing function according to the present invention. The light instrument having wireless network sharing function includes a decorative light 1 and a wireless network access point 2.

The decorative light 1 includes a base 11, a light generating component 12, a lamp shell 13, and a power switch 14. An accommodating space 111 is disposed within the base 11, and the wireless network access point 2 is disposed within the accommodating space 111. A neck portion 112 extends from the base 11, and one end of the neck portion 112 has an electrically conductive socket 113. The light generating component 12 is assembled with the electrically conductive socket 113.

The light generating component 12 is electrically connected to the electrically conductive socket 113. The light generating component 12 is incandescent bulb, fluorescent tube, halogens bulb, light emitting diode (LED) bulb, tungsten bulb or gas discharge bulb.

The lamp shell 13 is assembled on the end of the neck portion 112 and covers the light generating component 12. The lamp shell 13 projects light generated by the light generating component 12 out of the decorative light 1 and prevents the light generating component 12 from damaging.

The power switch 14 is a pressing switch or touching switch. The power switch 14 is disposed on the base 11 and electrically connected to a circuit board 21 of the wireless network assess point 2.

The wireless network assess point 2 is disposed within the accommodating space 111. The wireless network assess point 2 includes a circuit board 21, an antenna 22, a plurality of electric connectors 23, and a displaying unit 24. The circuit board 21 has traces (not shown) for the wireless network access point 2 (such as wireless network sharing circuit), and multiple electronic apparatus of user can access to the network via wireless connection. The circuit board 21 is electrically connected to a power wire 26 for connecting an external electronic power.

The antenna 22 includes an antenna joint 221 and a radiating body 222. The antenna joint 221 is fixed on the base 11 or the neck 112 of the decorative light 1 and electrically connected to the circuit board 21. The radiating body 222 is of pillar shape or stick shape, and includes a pivoting axis 222a electrically connected to the antenna joint 221.

The electric connectors 23 are network connectors, such as RJ45 connectors. The electric connectors 23 are dispose on the base 11 and electrically connected to the circuit board 21 for connecting a modem and multiple electronic apparatus (not shown) via network lines (not shown).

The displaying unit 24 composed of a plurality of light emitting diodes (LEDs) is disposed on the base 11 or the neck portion 112 and electrically connected to the circuit board 21 to display usage states of network connection.

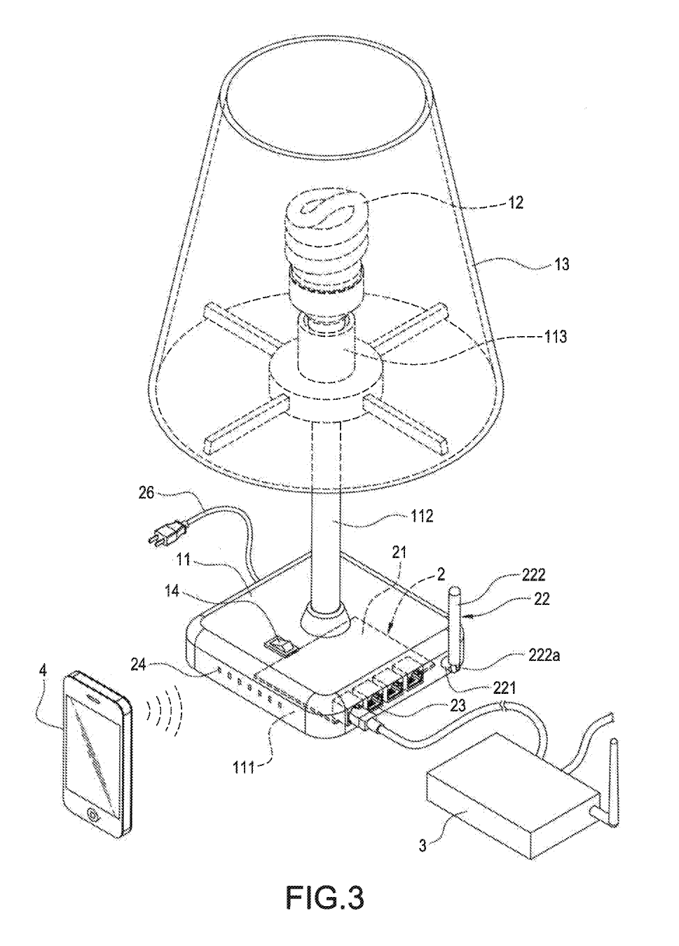

Reference is made to FIG. 3, which is a schematic view of usage state of the lighting instrument according to the present invention. The wireless network access point 2 of the decorative light 1 is electrically connected to the modem 3 at first when using the decorative light 1. After that, a wireless local area network equipment (or called WIFI) of the electronic apparatus 4 is turned on to emit signals to the wireless network access point 2. The signals are received by the antenna 22 and then transmitted to the circuit board 21 for processing, such that the electronic apparatus 4 is wireless connected to the wireless network access point 2, and the electronic apparatus is electrically connected to the modem 3 via the wireless network access point 2 to access internet. Therefore, the decorative light 1 placed on a desk becomes a wireless access point, and user can access to interact at any place in the house.

Alternately, when the power switch 11 is pressed, the operating power conducted to the circuit board 21 is transmitted to the light generating component 12 and lights the light generating component 12.

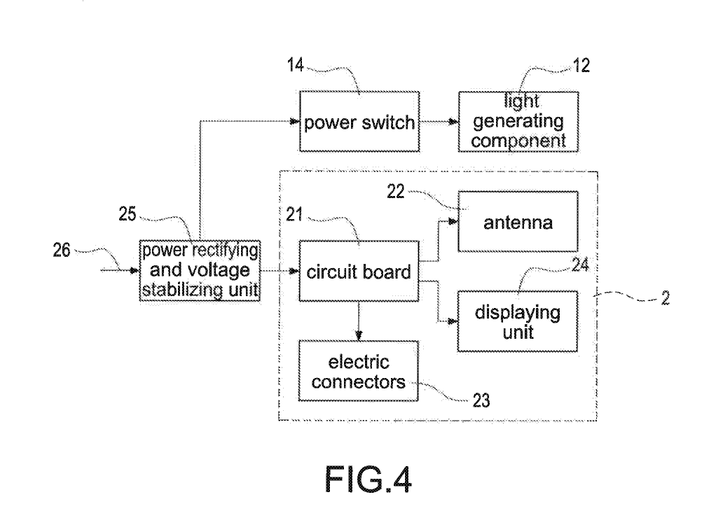

Reference is made to FIG. 4, which is a circuit diagram of the light instrument having wireless network sharing function according to the present invention. The decorative light 1 or the circuit board 21 further includes a power rectifying and voltage stabilizing unit 25. The decorative light 1 and the wireless network access point 2 are collectively using the same power line 26. An alternative power inputted to the power line 26 is converted and processed by the power rectifying and voltage stabilizing unit 25, and then is provided to the wireless network access point 2 and the light generating component 12.

Although the present invention has been described with reference to the foregoing preferred embodiment, it will be understood that the invention is not limited to the details thereof. Various equivalent nations and modifications can still occur to those skilled in this art in view of the teachings of the present invention. Thus, all such variations and equivalent modifications are also embraced within the scope of the invention as defined in the appended claims.

What is claimed is

1. A lighting instrument having wireless network sharing function, the lighting instrument comprising:
a decorative light; and
a wireless network access point assembled within the decorative light.

2. The lighting instrument having wireless network sharing function in claim 1, wherein the decorative light comprises:
a base comprising an accommodating space for accommodating the wireless network access point and a neck portion extending from the base, one end of the neck portion having an electrically conductive socket;
a light generating component electrically connected to the electrically conductive socket; and
a lamp shell assembled with the end of the neck portion and covering the light generating component.

3. The lighting instrument having wireless network sharing function in claim 2, further comprising a power switch disposed on the base and electrically connected to the wireless network access point.

4. The lighting instrument having wireless network sharing function in claim 3, wherein the light generating component is incandescent bulb, fluorescent tube, halogens bulb, light emitting diode bulb, tungsten bulb or gas discharge bulb.

5. The lighting instrument having wireless network sharing function in claim 4, wherein the wireless network assess point comprises:
a circuit board having traces for the wireless network assess point;
an antenna electrically connected to the circuit board;
a plurality of electric connectors electrically connected to the circuit board; and
a displaying unit disposed on the base or the neck portion and electrically connected to the circuit board for displaying usage states of network connection.

6. The lighting instrument having wireless network sharing function in claim 5, wherein the antenna comprises a antenna joint and a radiating body, the antenna joint is fixed on the base or neck portion of the decorative light and electrically connected to the circuit board, the radiating body comprises a pivoting axis electrically connected to the antenna joint.

7. The lighting instrument having wireless network sharing function in claim 6, wherein the radiating body is of pillar shape or stick shape.

8. The lighting instrument having wireless network sharing function in claim 7, wherein the electric connectors are network connectors.

9. The lighting instrument having wireless network sharing function in claim 8, wherein the electric connectors are RJ45 connectors.

10. The lighting instrument having wireless network sharing function in claim 9, wherein the displaying unit is composed of a plurality of light emitting diodes.

11. The lighting instrument having wireless network sharing function in claim 10, wherein the circuit board further comprises a power rectifying and voltage stabilizing unit electrically connected to the light generating component.

12. The lighting instrument having wireless network sharing function in claim 10, wherein a power rectifying and voltage stabilizing unit is disposed within the base and electrically connected to the light generating component and the circuit board.
